(19) United States
(12) Patent Application Publication
(10) Pub. No.: US 2002/0071532 A1
(43) Pub. Date: Jun. 13, 2002

(54) Private branch exchange for interconnecting data networks

(76) Inventors: Thomas Bebko, Kamen (DE); Michael Winkelmann, Bochum (DE); Wilfried Krug, Witten (DE)

Correspondence Address: BELL, BOYD & LLOYD, LLC, P. O. BOX 1135, CHICAGO, IL, 60690-1135, US

(21) Appl. No.: 09/907,399

(22) Filed: Jul. 17, 2001

(30) Foreign Application Priority Data
Jul. 19, 2000 (DE) 100 35 167.0

(51) Int. Cl. H04M 11/00

(52) U.S. Cl. 379/90.01

(57) ABSTRACT

For interconnecting data networks which use cabling, which is actually provided for other purposes, as transmission medium for data packets, a private branch exchange is provided for connecting subscriber terminals via subscriber lines. The private branch exchange has an integrated interconnecting device via which data packets which are transmitted via the subscriber lines and which are coded into signals outside a frequency range used for communication with the subscriber terminals are extracted from a first subscriber line and extracted data packets are injected into a second subscriber line.

### BACKGROUND OF THE INVENTION

1. Field of the Invention

The present invention relates to a private branch exchange for interconnecting data networks which utilize cabling which is actually provided for other purposes, such as, for example, telephone cabling or cabling for supplying electricity, as a transmission medium for data packets. Such a data network is frequently called a home network.

2. Description of the Prior Art

The home networking technology is currently promoted for networking data processing devices, especially in the home domain. For this purpose, the data processing devices are interconnected via cabling which is actually provided for other purposes. By using preexisting cabling such as, for example, in-house telephone and/or electricity supply cabling, no additional installation of connecting cables is required for networking data processing devices within the area of the existing cabling.

For transmitting data between the data processing devices networked in this manner, data packets to be transmitted are coded into signals outside a frequency range used in connection with the actual purpose of the cabling, and fed into the cabling. In the case of home networking via existing telephone cabling, for example, a frequency range from 5.5 MHz to 9.5 MHz not used by the telephony service is used for transmitting data packets so that telephone calls conducted via the telephone cabling at the same time are not impaired.

When complex data networks are set up via the home network technology, it is frequently a problem to interconnect various branches of a home network; that is, for example, various lines of telephone cabling which are separate with respect to telephony and/or to couple these lines to an ongoing communication network without impairing the actual function of the cabling used as transmission medium.

It is, therefore, an object of the present invention to specify an arrangement which allows data networks which use cabling, which is actually provided for other purposes, as a transmission medium, to be coupled together and, in particular, to couple together home networks and/or branches of home networks.

### SUMMARY OF THE INVENTION

A private branch exchange according to the present invention makes it possible to couple various branches of telephone cabling together to form a complex home network. Interconnection by a private branch exchange is advantageous since a multiplicity of interconnectable subscriber lines usually come together at a place of a communication system which is intended for connecting a private branch exchange. An interconnecting device for exchanging home network data packets between various subscriber lines, which, according to the present invention, is integrated in the private branch exchange, makes it possible to implement a multi-subscriber-line home network.

According to a further embodiment of the present invention, the interconnecting device can be coupled to a gateway device of the private branch exchange. The gateway device is used for coupling the private branch exchange to one or more communication networks such as, e.g., to a so-called local area network (LAN) or to a public communication network. Connecting the interconnecting device to the gateway device makes it possible to interconnect the home network made up of the subscriber lines to the ongoing communication network. In this manner, the home network can be coupled to the Internet via the public communication network; for example, via a gateway device constructed as a modem.

Advantageously, a form of resource administration can be provided for jointly administering transmission resources such as, e.g., the respective available transmission bandwidth or the quality of service of the data networks which are, in each case, interconnected. In this arrangement, transmission resources available for communication with the terminals also can be included in the joint resource administration. Joint resource administration allows the transmission resources of all communication devices involved to be optimally matched to one another. Advantageously, a common administration interface can be provided for controlling the joint resource administration.

According to an advantageous embodiment of the present invention, the interconnecting device can be controlled by a central processor of the private branch exchange. In this manner, it is possible, e.g., to control the extracting and injecting of data packets or, respectively, the injecting and extracting of the signals representing the data packets, as needed.

The interconnecting device can be implemented via a digital signal processor and/or via a so-called FIR (Finite Impulse Response) filter. In addition, the interconnecting device can be integrated in the central processor. Furthermore, the interconnecting device and the central processor can be implemented, at least partially, via a common integrated circuit or as a program module running on a common microprocessor or microcontroller.

According to a further advantageous embodiment of the present invention, the interconnecting device can have a bridge and/or router function for selectively forwarding data packets via address information which is, in each case, contained in the data packets and which identifies a transmission destination. In this manner, the data packets to be transmitted can be individually directed to their transmission destination. The bridge and/or router function is particularly advantageous in the case of an interconnection to an ongoing communication network such as, e.g., the Internet. In this case, data packets which are only to be transmitted within the home network are not forwarded by the interconnecting device to the gateway device leading into the ongoing communication network so that the gateway device load is reduced.

Additional features and advantages of the present invention are described in, and will be apparent from, the following Detailed Description of the Preferred Embodiment and the Drawings.

### DESCRIPTION OF THE DRAWINGS

FIG. 1 shows a communication system with a private branch exchange interconnecting a home network; and

FIG. 2 shows an interconnecting device of the private branch exchange for interconnecting the home network.

### DETAILED DESCRIPTION OF THE PREFERRED EMBODIMENTS

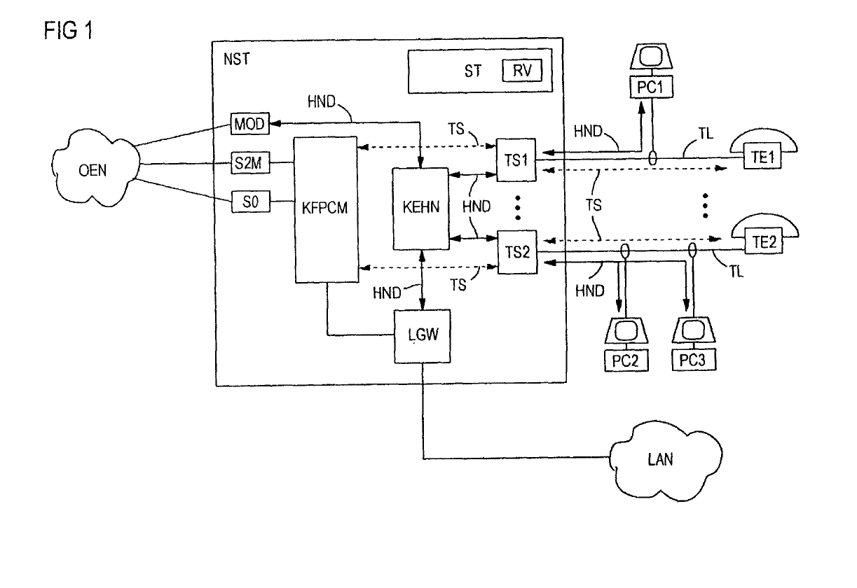

In FIG. 1, a communication system with a private branch exchange NST according to the present invention, which is connected to a public communication network OEN, is diagrammatically shown. The private branch exchange NST has subscriber circuits TS1, TS2, . . . , to which subscriber terminals TE1, TE2, . . . are connected via subscriber lines TL. For reasons of clarity, FIG. 1 only shows subscriber circuit TS1 to which a subscriber line TL leading to subscriber terminal TE1 is connected, and subscriber circuit TS2 to which a further subscriber line TL leading to subscriber terminal TE2 is connected is explicitly shown. The private branch exchange NST exhibits, as further functional components, a LAN gateway LGW connected to a local area network LAN, a PCM (Pulse Code Modulation) switching network, an interconnecting device KEHN and a central processor ST with integrated resource administration RV.

The interconnecting device KEHN is coupled via a modem MOD, e.g. a so-called ADSL (Asymmetric Digital Subscriber Line) modem or a so-called power line modem, which is integrated into the private branch exchange NST, to the public communication network OEN. The interconnecting device KEHN is also connected to the LAN gateway LGW and to the subscriber circuits TS1, TS2, . . .

The PCM switching network KFPCM is essentially used for establishing telephony links among the subscriber terminals TE1, TE2, . . . and between the subscriber terminals TE1, TE2, . . . and the public communication network OEN or the local area network LAN. For this purpose, the PCM switching network KFPCM is coupled to the public communication network OEN both via an S0 interface S0 and via an S2M interface S2M of private branch exchange NST, to the local area network LAN via the LAN gateway and to the subscriber terminals TE1, TE2, . . . via the subscriber circuits TS1, TS2, . . . In association with the telephony links, telephony signals TS are exchanged between the subscriber terminals TE1, TE2 and the PCM switching network KFPCM as indicated by dashed double arrows. As is usual in telephony traffic, the telephoy signals TS occupy a frequency range from 300 Hz to 3400 Hz.

Apart from the telephony signals TS, home network data packets HND which are injected or, respectively, extracted by personal computers PC1, PC2 and PC3 coupled to the subscriber lines TL are additionally transmitted via the subscriber lines TL. For the present exemplary embodiment, it will be assumed that the personal computer PC1 is coupled to the subscriber line leading to subscriber terminal TE1 and personal computers PC2 and PC3 are coupled to the subscriber line leading to subscriber terminal TE2.

For the transmission, the home network data packets HND are coded into pulse-position modulated signals with a frequency range from 5.5-9.5 MHz in the present exemplary embodiment. This transmission method is also called homePNA 1.0 (Phoneline Networking Association) and allows a data transmission rate of 1 Mbit/s. As a variant, the more capable transmission method homePNA 2.0 can also be used with which a data transmission rate of 10 Mbit/s can be achieved when using a quadrature amplitude modulation (QAM) in the frequency range from 1-10 MHz. Due to the great frequency spacing between the frequency range used for transmitting the telephony signals TS and the frequency range used for transmitting the home network data packets HND, the telephony signals TS and the home network data packets HND will not interfere with one another even in a simultaneous transmission. The transmission of home network data packets HND is indicated via continuous double arrows in FIG. 1.

The home network data packets HND to be transmitted by the personal computers PC1, PC2 and PC3 are, in each case, injected into the relevant subscriber line TL and transmitted via this line to the subscriber circuit TS1 and TS2, respectively. The subscriber circuits TS1 and TS2, respectively, are transparent with respect to the frequency range from 5.5-9.5 MHz used for transmitting the home network data packets HND so that the home network data packets HND are transmitted undisturbed via the subscriber circuits TS1 or TS2 to the interconnecting device KEHN or, in the reverse direction, from the interconnecting device KEHN to the personal computers PC1, PC2 or PC3.

The interconnecting device KEHN switches home network data packets HND between the subscriber lines TL connected to the subscriber circuits TS1 and TS2, the local area network LAN and the public communication network OEN. The interconnecting device thus provides for a multi-subscriber-line exchange of home network data packets HND. In the present exemplary embodiment, the interconnecting device KEHN is equipped with bridge functions; that is to say, received home network data packets HND are forwarded by the interconnecting device KEHN in dependence on address information contained in the home network data packets HND. In this arrangement, a home network data packet HND is only forwarded by the interconnecting device KEHN to the relevant one of the circuits TS1, TS2, MOD or LGW which leads to the transmission destination identified by the address information. Thus, for example, home network data packets HND which are only to be exchanged between personal computers PC1 and PC2 are only exchanged between subscriber circuits TS1 and TS2 by the interconnecting device KEHN, and not forwarded to modem MOD or to LAN gateway LGW. This significantly reduces the load on the modem MOD and the LAN gateway LGW.

The interconnecting device KEHN is controlled by the central processor ST of the private branch exchange NST. In particular, the transmission resources of the interconnecting device KEHN, of the modem MOD, of the LAN gateway LGW and of the PCM switching network KFPCM are jointly administered by the resource administration RV. The resource administration RV thus administers both the transmission resources for the telephony signals TS and the transmission resources for the home network data packets HND.

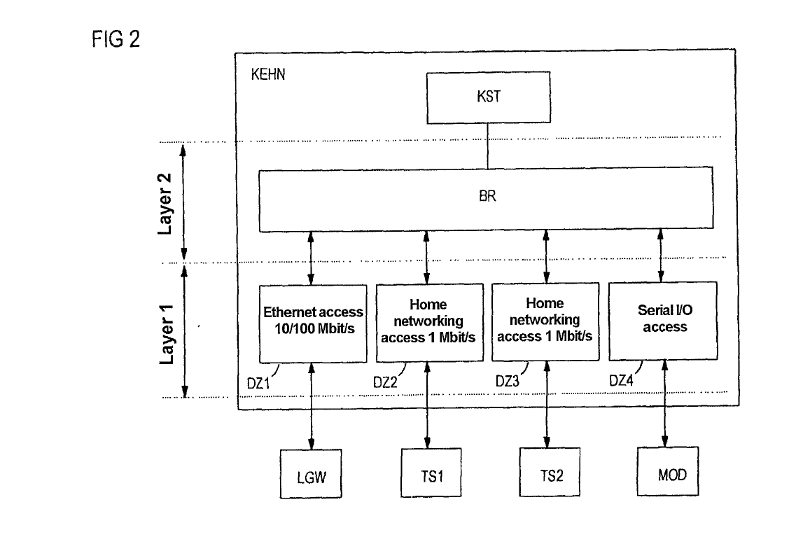

FIG. 2 shows a block diagram of the interconnecting device KEHN. It exhibits, as functional components, a controller KSD, a bridge device BR connected to the controller KSD and various data access chips DZ1, DZ2, DZ3 and DZ4. As indicated by dotted lines, the data access chips DZ1, . . . , DZ4 operate on the physical layer, that is to say on layer 1, of the so-called OSI (Open System Interconnect) reference model while the bridge device BR operates on the data link layer, or layer 2, of the OSI reference model.

In the present exemplary embodiment, the data access chip DZ1 is used for physical access to the LAN gateway LGW connected to it, in accordance with the so-called Ethernet protocol. Data access chips DZ2 and DZ3 are connected to the subscriber circuits TS1 and TS2 and are used for physical access to the signals coding the home network data packets HND in the frequency range from 5.5-9.5 MHz. The data access chip DZ4, finally, is coupled to the modem MOD and is used for serial transmission of data between the interconnecting device KEHN and the modem MOD. In particular, the data access chips DZ1, . . . , DZ4 have the task of detecting or, respectively, generating preambles of layer-1 data packets and of recognizing collisions of layer-1 data packets on the respective transmission medium. The data access chips DZ1, . . . , DZ4 are controlled by the controller KST so that, if necessary, layer-1 data packets can be injected and extracted, respectively. Due to similarities between the Ethernet protocol and the home networking protocol, the data access chip DZ1 and the data access chips DZ2, DZ3 can be implemented via the same circuit chip such as, e.g., the AM79C901 transceiver by AMD (Advanced Micro Devices, Inc.). As an alternative, the layer-1 data access chips DZ2, DZ3 can also be implemented, for example, via the integrated circuit chip CX24611 by Conexant, which is similarly suitable for homePNA 1.0 and homePNA 2.0.

The home network data packets HND to be exchanged between the LGW, TS1, TS2 and MOD circuits are transmitted from the data access chips DZ1, . . . , DZ4 to the bridge device BR via a protocol interface between the physical layer and the data link area. This bridge device has a buffer memory for temporarily storing a home network data packet HND to be transmitted for every one of the data access chips DZ1, . . . , DZ4. Such a buffer memory allows data packets received at a predetermined transmission rate to be forwarded at a transmission rate which differs from that. Thus, for example, data packets received at a high transmission rate of 100 Mbit/s from the LAN gateway LGW can be temporarily stored until they have been completely forwarded via the comparatively slow home networking data access chip DZ2 with a transmission rate of 1 Mbit/s.

The bridge device BR operating in the data link layer evaluates an address information item contained in a completely received home network data packet HND and identifying a transmission destination and, depending on this information, transmits the data packet only to the relevant one of the data access chips DZ1, . . . , DZ4 which leads to the transmission destination. If necessary, the transmission rate is adapted during this process.

According to an alternative embodiment of the present invention, a routing function dependent on an address information item can also be implemented by a router device (not shown) operating on the network layer, on layer 3, of the OSI reference model, instead of by a bridge device BR. In accordance with a further embodiment, the routing function can also be omitted and only a repeater function provided for the interconnecting device KEHN.

The controller KST administers, in particular, the transmission resources such as, e.g., the transmission bandwidth available in the individual transmission channels or other quality-of-service parameters. The controller KST of the interconnecting device KEHN is preferably interconnected to the resource administration RV of the private branch exchange NST so that the transmission resources for the telephony signals TS and the transmission resources for the home network data packets HND can be administered jointly.

Although the present invention has been described with reference to specific embodiments, those of skill in the art will recognize that changes may be made thereto without department from the spirit and scope of the invention as set forth in the hereafter appended claims.

We claim as our invention:

1. A private branch exchange, comprising,
a plurality of subscriber circuits for connecting a plurality of subscriber terminals via a plurality of subscriber lines;
a plurality of data packets which are coded into signals outside a frequency range used for communication with the plurality of subscriber terminals, the plurality of data packets being transmitted via a plurality of subscriber lines; and
an active interconnecting device coupled to the plurality of subscriber circuits for extracting the plurality of data packets from a first one of the plurality of subscriber lines and for injecting the extracted data packets into a second one of the plurality of subscriber lines.

2. A private branch exchange as claimed in claim 1, wherein the subscriber circuits are transparent for a frequency range used for transporting the data packets.

3. A private branch exchange as claimed in claim 1, further comprising,
a gateway device coupled to the interconnecting device for connection to an ongoing communication network for exchanging data packets between the ongoing communication network and the subscriber lines.

4. A private branch exchange as claimed in claim 13, wherein the gateway device is a modem.

5. A private branch exchange as claimed in claim 13, wherein the ongoing communication network is a public communication network.

6. A private branch exchange as claimed in claim 3, wherein the ongoing communication network is a local area network.

7. A private branch exchange as claimed in claim 1, further comprising,
a central processor, wherein the interconnecting device, in order to be controlled, is coupled to the central processor.

8. A private branch exchange as claimed in claim 7, wherein the interconnecting device has access to private-branch-exchange-internal signaling information in the central processor.

9. A private branch exchange as claimed in claim 7, wherein the central processor includes resource administration capabilities for jointly administering transmission resources available for the data packets and transmission resources available for the communication with the subscriber terminals.

10. A private branch exchange as claimed in claim 1, wherein the interconnecting device has at least one of bridge and router functions for both forwarding the data packets, depending on respective address information contained in the data packets, and identifying a transmission destination.
